(19) United States
(12) Patent Application Publication
(10) Pub. No.: US 2022/0231773 A1
(43) Pub. Date: Jul. 21, 2022

(54) REPLAY REALIZATION IN MEDIA PRODUCTION USING FIFTH GENERATION, 5G TELECOMMUNICATION

(71) Applicant: Telefonaktiebolaget LM Ericsson (publ), Stockholm (SE)

(72) Inventors: Mohamed Ibrahim, Aachen (DE); Ali El Essaili, Aachen (DE); Thorsten Lohmar, Aachen (DE)

(21) Appl. No.: 17/614,860

(22) PCT Filed: May 29, 2019
(86) PCT No.: PCT/EP2019/064051

§ 371 Date: Nov. 29, 2021

(51) Int. Cl. H04H 60/04; H04H 20/04; H04N 5/268

(52) U.S. Cl. CPC H04H 60/04; H04N 5/268; H04H 20/04

(57) ABSTRACT

A method of providing video content to a production studio by selecting a video stream from multiple wireless video cameras each arranged for providing at least a High Quality, HQ, and a Low Quality, LQ, video output and comprising an internal storage, said method comprising selecting one of the cameras as a live camera thereby instructing said live camera to provide HQ video output and selecting the remaining cameras as replay cameras thereby instructing said replay cameras to provide LQ video output and internally store HQ video, such that content provided to said production studio is said HQ video from said live camera, receiving an instruction to provide stored HQ video from one of said replay cameras, and instructing said one of said replay cameras to provide said stored HQ video, such that content provided to said production studio is said stored HQ video from said replay camera.

### TECHNICAL FIELD

The present disclosure generally relates to the field of video content broadcasting and more specifically to methods and devices for enabling transmission of video content to production studio from mobile video recording equipments.

### BACKGROUND

Live events are one of the major broadcasts on Television, TV, schedules nowadays. TV producers invest a lot of effort to produce Live shows and bring it to consumers in the highest possible production quality. The basic tools used today for producing Live shows and pre-recorded shows are not very different. However; in case of live shows the producer needs to ensure that the various important events happening in the show are delivered to the consumer in a clear sequence.

FIG. 1 depicts how the production process of a live event occurs. In this disclosure, it is assumed that an event producer is interested in covering an outdoor event in a stadium.

The production team distributes their cameras around the stadium and collect the feeds from the different cameras in an on-site studio. The on-site studio could be a room in the stadium or a van with the necessary equipment. Alternately the on-site studio could also be a cloud based. After the media content is processed, it is sent as a single stream to the production studio. There, the stream could be distributed using satellite link or any other available network.

The above system is assuming that all the cameras are connected via wires to an Outside Broadcast Van, OBV, where all cameras are sending high quality video, the high quality video is stored in a storage in the studio, where it is possible to store large amount of data for later viewing, such as for replays.

In todays wired system, all camera feeds are transmitted at high quality so the replay operation can be completely performed in the local production studio. When cameras are connected via A Fifth Generation, 5G, telecommunication system, not all streams are available at high quality at the studio. In order to provide a high quality replay, high quality feeds for replayed content need to be fetched from the other cameras.

However, media producers are moving towards using 5G/New Radio, NR, to connect cameras to the on-site studio. This will simplify and speed-up the process of setting up the component for producing media. The media production doesn't depend on securing wires, it can also reach difficult area, where wiring is not possible and makes movement much easier, which is necessary in dynamic environments.

Therefore, it is desirable to enable a system to allow wireless cameras to transmit High Quality video making efficient use of the available radio resources such as bandwidth.

### SUMMARY

In a first aspect of the present disclosure, there is presented a method of providing video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera.

The method comprises the steps of selecting, by a stream controller, one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera, receiving, by said stream controller, an instruction to provide stored HQ video content from one of said replay cameras, and instructing, by said stream controller, said one of said replay cameras to provide said stored HQ video content, such that video content provided to said production studio is said stored HQ video content from said replay camera.

By moving to 5G/NR between the cameras and the multi-viewer, the producer has to utilize its limited radio bandwidth, where it's not possible to receive high quality video from all cameras. The producer receives high quality from only the on-air camera, while for monitoring it receives low quality from other cameras, In this scenario, the production team responsible for replays will not get all streams in higher quality at the storage in the studio. Therefore it will not be possible to form replays from higher quality stream because only low quality stream is sent to the storage at the studio. It's also not possible to store the high-quality stream in the cameras because the camera has limited storage.

An advantage of the present disclosure is that the proposed solution allows replays and post on-air stream to be prepared and sent, without the need to have all the high-quality streams from all cameras. This technique saves bandwidth on the radio side. A further advantage is that this technique saves storage on both the camera and the studio.

Furthermore, the inventors consider it to be advantageous that the present technique schedules the transmission of the high-quality stream, allows the network to utilize its resources and sends stream without exhausting the radio resource and affecting the main video source.

A live camera may alternately be referred to as the on-air camera. The stream controller may assign one camera as being the live camera. This may be based on an instruction received by the stream controller from a production studio, or for example based on the position of a camera that ensures good coverage of the event being covered. A live camera provides video content in a High Quality, for example High Definition, HD, Full HD, Ultra High Definition, UHD, 4K UHD, 8K UHD etc. The exact resolution with which the camera transmits may be determined by the production studio based on the available radio resources and/or a desired resolution of broadcast.

The other cameras, i.e., replay cameras are instructed by the stream controller to stream at a lower quality. The skilled person understands that the replay cameras only have to stream at a quality lower than that being streamed by the on-air camera. This ensures an optimal usage of the available radio resources. Simultaneously a high quality stream is also stored locally each of the replay cameras. It may be understood that the duration for which high quality video can be stored locally at the replay cameras depends on the amount of storage space available and the quality of the video stream itself. Alternately, the quality of the stream may be adjusted in such a manner that the replay cameras are able to store video content for a predetermined duration of time, for example 10 minutes.

The instruction sent by the stream controller may be in a JavaScript, Open Notation, JSON, format specifying an identifier for a camera and further specifying start and end times of the requested content. Alternately, instead of specifying start and end times, start time and duration may be requested. The instruction may also comprise an indication of the time at which the requested content should go on air. It may be understood by the skilled person that the requested video content may be within the limits of the stored content at the replay cameras.

According to an example, the step of instructing further comprises the step of instructing, by said stream controller, said live camera to provide LQ live video content to said stream controller. When content is being replayed, the live camera may continue to transmit video content in a low quality mode, thereby ensuring optimal usage of the available radio resources.

According to an example the replay cameras store said HQ video content for at least 10 minutes.

In an embodiment, the stream controller stores video streams from all of said plurality of cameras to a central storage device.

According to an exemplary embodiment, the stream controller reassigns one of said plurality of replay cameras as a live camera and said live camera as a replay camera.

In a second aspect of the present disclosure, there is presented a stream controller arranged to provide video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera.

The stream controller according to the second aspect of the present disclosure comprises select equipment arranged for selecting one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera, receive equipment arranged for receiving an instruction to provide stored HQ video content from one of said replay cameras, and instruct equipment arranged for instructing said one of said replay cameras to provide said stored HQ video content, such that video content provided to said production studio is said stored HQ video content from said replay camera.

It is understood that the benefits and advantages of the first aspect of the present disclosure are also associated with the second aspect of the present disclosure, being the stream controller arranged to provide video content to a production studio by selecting an input video stream from a plurality of wireless video cameras. The stream controller may be located in the Radio Access Network, RAN, the 5G core network or on an external application server.

According to an exemplary embodiment of the second aspect of the present disclosure, the instruct equipment is further arranged for instructing said live camera to provide LQ live video content to said stream controller.

According to an embodiment of the second aspect of the present disclosure, the stream controller stores video streams from all of said plurality of cameras to a central storage device.

According to an embodiment of the second aspect of the present disclosure, the stream controller reassigns one of said plurality of replay cameras as a live camera and said live camera as a replay camera.

According to a third aspect of the present disclosure, there is presented a wireless camera arranged to provide video content to a production studio, wherein said wireless camera is arranged to provide said video content in at least a High Quality, HQ, format and Low Quality, LQ, format.

The wireless camera comprises receive equipment, arranged to receive a selection message from a stream controller, selection equipment, arranged to select either said HQ format or said LQ format for transmission to said stream controller based on said received selection message, memory arranged for temporarily storing video generated by said wireless camera, extract equipment, arranged for extracting video content from said stored video based on a replay instruction received from said stream controller.

According to a fourth aspect of the present disclosure there is presented a system for providing video content by selecting a video stream from a plurality of video streams, said system comprising, a plurality of wireless cameras, wherein each of said wireless video cameras are arranged for providing at least a High Quality, HQ, and a Low Quality, LQ, video output, said wireless video cameras further comprising an internal storage arranged to locally store a video output from said wireless camera, a stream controller arranged for selecting one of said plurality of cameras as a live camera and remainder of said plurality of cameras as replay cameras, said stream controller further arranged to perform a method according to any of the claims 1-5, and a production studio arranged to receive video content from said live camera selected by said stream controller.

In a fifth aspect of the present disclosure, there is presented a computer-readable storage medium comprising a computer program, which computer program comprises instructions which, when executed on at least one processor, cause the at least one processor to carry out a method in accordance with any of the methods as disclosed in the present disclosure.

### BRIEF DESCRIPTION OF THE DRAWINGS

FIG. 1 schematically illustrates an outdoor production system.

FIG. 2 schematically illustrates an architecture for an outdoor production system according to the prior art.

FIG. 3 schematically illustrates an architecture for an outdoor production system according to the present disclosure.

FIG. 4 schematically illustrates an architecture for an outdoor production system according to the present disclosure.

FIG. 5 schematically illustrates a timeline for videos produced according to the present disclosure.

FIG. 6 schematically illustrates a method according to the present disclosure.

FIG. 7 schematically illustrates a stream controller according to the present disclosure.

FIG. 8 schematically illustrates a video camera according to the present disclosure.

### DETAILED DESCRIPTION

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of subject matter to those skilled in the art.

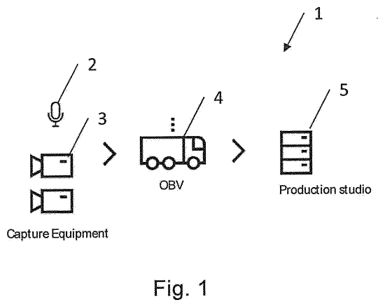

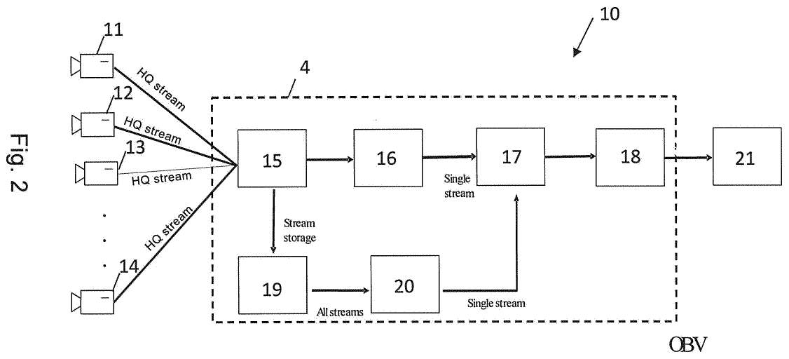

FIG. 1 schematically illustrates an outdoor production system, 1. Production system 1 typically comprises a plurality of audio capture equipment 2 and video capture equipments 3. They provide the generated content to an Outside Broadcast Van, OBV 4. An architecture of an OBV 4 is shown in more detail in FIG. 2. Typically the OBV 4 is responsible for receiving multiple audio/video streams from the plurality of audio and video capture equipments 2, 3 and to select one stream from the available plurality of streams, thereby providing a single stream of audio visual content to the production studio 5. The production studio 5 may add further content such as commentary and/or logos before broadcasting.

FIG. 2 schematically illustrates an architecture for an outdoor production system, 10 according to the prior art. The system 10 shown in FIG. 2 assumes a wired setup wherein all the cameras 11-14 are wired and therefore can transmit HQ video content without constraints on radio resources. All cameras 11, 12, 13, 14, output are sent in high quality to the on-site studio, 4. A producer team is viewing all inputs on multiple screens in a multi-viewer 15 and according to the content on the screen they choose which camera should be considered as the main input to the output stream, which goes to the production studio 21. The producer can choose multiple input streams and mix them in one output using the live mixer 16 or the recording mixer 17. The output stream afterwards is sent for further processing 18, adding overlays and then sent for encoding 19. The encoded stream is sent over network to the production studio 21. The studio 21 prepares the final stream for distribution by, for example, adding commentary or channel logos.

The stream from all cameras 11-14, are stored in the storage 19 available at on-site studio 4 in the highest quality. This stream is analyzed by the production team and used for viewing later-on, either after the event or during replays. Where the production team are preparing the replays while the main stream is on air, once the replay is ready, it goes on-air and the live event is put on hold.

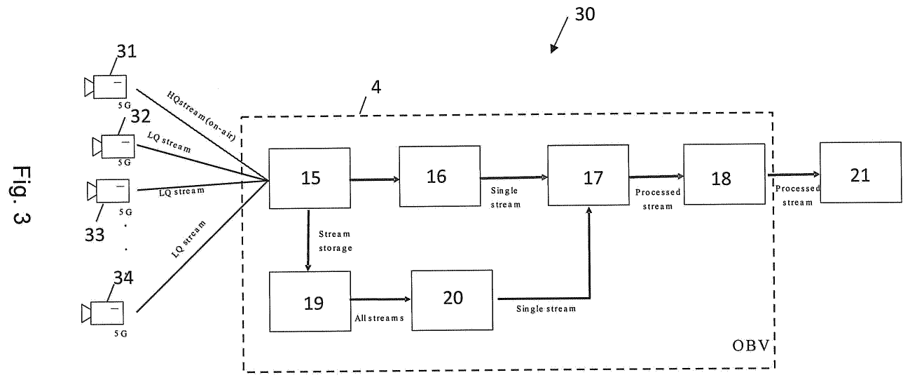

FIG. 3 schematically illustrates an architecture 30 for an outdoor production system according to the present disclosure. The main difference between the system 10 shown in FIG. 2 and the system 30 shown in FIG. 3 is the use of wireless cameras 31-34 which put a constraint on the quality of the video content that can be provided by each of the video cameras.

FIG. 4 schematically illustrates an architecture 40 for an outdoor production system according to the present disclosure. Assume the program crew has moved to the stadium to cover an important football match, the event is covered with a plurality of cameras 31-34, where all the cameras 31-34 are equipped with 5G modems, limited storage space, multi encoder. Although only 4 cameras as shown in the figure, the skilled person understands that the teaching of the present disclosure may be extended to more or less number of cameras depending on the event being covered. The crew distributes the cameras 31-34 around the stadium and setup their 5G network setup to connect all the cameras to the on-site production studio. It is assumed that the stadium is covered via multiple e-NodeBs as shown in FIG. 4.

The system is further explained with the assumption that camera 31 is the live camera or the on-air camera, and the remaining cameras 32-34 are the replay cameras. Each camera 31-34, is connected to the production studio via a media channel and control channel. Only the on-air camera 31, is sending high quality stream, while other cameras 32-34 are sending only low-quality stream for monitoring. Each camera is producing both high quality and low-quality stream, it sends the requested quality to the stream sink receiver. Each camera has a limited storage, where it can store a certain duration of the high-quality stream. It may be beneficial to ensure that the camera should always store at least the latest 10 minutes of the event.

The stream sink receiver 42 is receiving all streams from all cameras 31-34 and saves them to a storage 19, while the main stream is sent for the live mixer 16. The live mixer 16 consists of multiple views, where the production team is viewing all the streams from all cameras and send the high-quality stream to live production.

The recording mixer 20 is viewing all streams and produce replays from all cameras. All processing required for production, overlays are performed by the processing equipment 17.

The Encoder 18 is responsible for encoding the main final stream and sending it to the remote studio for distribution. The Stream controller 41 is the control node of the streams, it sends requests to the cameras 31-34 to send specific quality or specific duration of the stored stream. This information is derived from the recording mixer 20 or the live mixer 16. The stream controller 41 may be located in the Radio Access Network, RAN, the 5G core network or on an external application server.

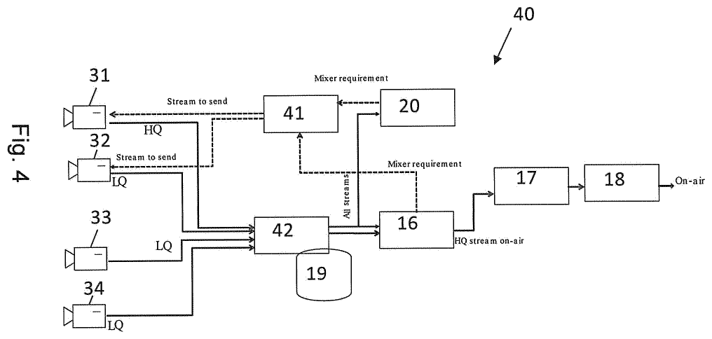

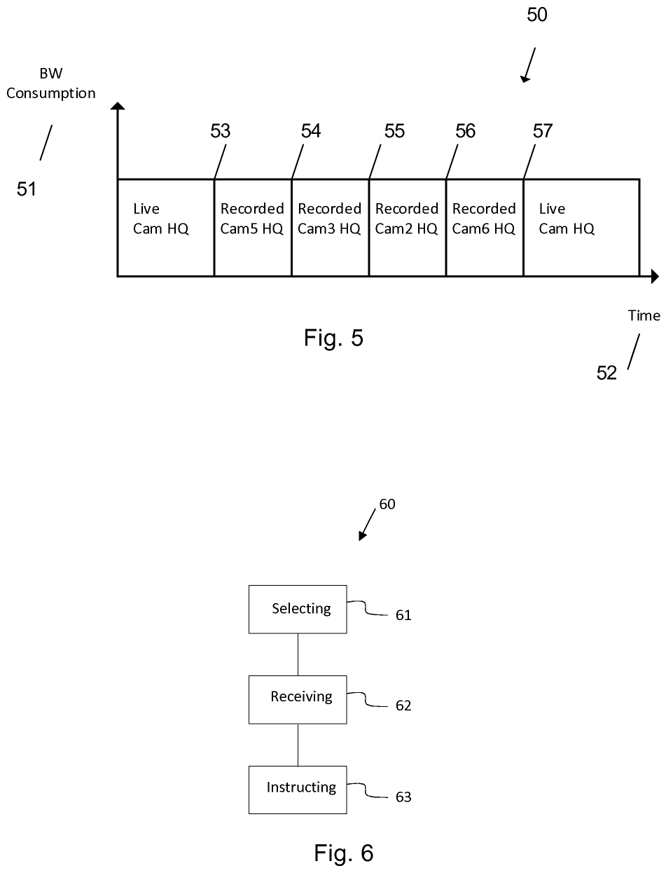

FIG. 5 schematically illustrates a timeline 50 for videos produced according to the present disclosure. The time line has time 52 on the x-axis and bandwidth consumption 51 on the y-axis. The time line 50 shows that until instant 53, the video content is from the live camera is provided. In the example, it is foreseen that replays are to be provided from different cameras, each for a particular, duration of time. The cameras that are to provide the replays and the particular durations for which they are to provide the replays may be determined by the production studio. For example consider that the production studio came up with a particular sequence as shown in FIG. 5.

After instant 53, camera number 5 provides the recorded HQ content until instant 54. After instant 54, replay is requested from camera 3 in a high quality format. Similarly, after instants 55 and 56 HQ recorded video content is provided from cameras 2 and 6 respectively. Replays may be requested from multiple cameras in order to view an event of interest from multiple angles. At an instant 57, the live stream from the main camera is resumed. Between the instants 53 and 57, the live stream from main camera may be paused, such that the live camera does not stream any content at all, or may be streamed in a LQ stream to the stream controller in order to conserve bandwidth.

The present disclosure proposes a technique to manage replays from multiple cameras in high quality, despite not sending all the highest quality from all cameras all the time. After composing/defining the replays on the low quality available at the studio storage, the producer is sending a request for all involved cameras to send a specific portion of the video stored in its short memory to the server at specific time-stamp.

The on-air live video is typically paused (can be sent at low quality for monitoring) and the replay camera streams the signalled video duration on high quality. Once the replay is sent, the live camera resumes streaming in high quality.

Another proposed solution is that both the cameras and the network are scheduling the transmission of the high-quality video that should be used in the replay in the background, without leaving high impact on the high quality stream currently on-air. If the camera doesn't get a transmission request after certain period of time, it deletes the high-quality stream from its local memory. For cameras generating a LQ stream, an additional high-quality stream can be transmitted on a demand basis as instructed by the producer. The producer signals the duration of the video to be sent and cameras are only storing HQ stream for a short period of time.

A typical scenario where the production team is preparing a replay according to the teaching of the present disclosure is explained below. Although several steps are enlisted below in a numerical fashion, the skilled person understands that they do not represent a mandatory sequence to be followed. Numerals are provided merely to enhance the readability.

1. Cameral is sending high quality stream to the stream sink server.

2. Other cameras are sending low quality stream to the stream sink server, while they store the last 10 minutes of the high quality stream to their local storage. The storage period can be configured by the producer.

3. The stream sink server is storing all the low quality and high quality to a storage, while sending all the streams to the live mixer.

4. The live mixer is viewing all streams and forwards the high-quality stream for further processing.

5. The live mixer can send a request to the stream controller to change the quality from one camera to the other.

6. The crew are watching the feed from all cameras and decides there is a replay scene for the last 3 minutes is required. The replay duration and start and end times can be indicated by the producer.

7. The crew uses the recording mixer to seek back to the last 3 min, they decide to use a combination of 4 cameras to compose the replay, in a particular sequence.

8. The recording mixer sends message to the stream controller to request the duration of the HQ stream from the four cameras at specific time stamps.

9. The stream controller sends to each camera instruction to send the high-quality stream for the needed scene, at specific time-stamp. The instruction sent by the stream controller, may comprise of

a. Camera id: Id of the camera

b. Video type: Recorded—the camera is instructed to pull the video from the memory

c. Quality: The quality of video required

d. Video start: time stamp of the beginning of the recorded video

e. Video end: Time stamp of the end of the recorded video

f. Stream Start: Time stamp when the camera should start streaming the recorded video

10. As shown in FIG. 5, once the timestamp is approached Cam #5 starts streaming recorded high-quality video while all other cameras are streaming live video at low quality.

11. Alternative solution to step 9,10 is that instead of sending the feed recorded from the stream directly on-air, the recorded camera is getting instruction to send the recorded stream as a background upload. In such a situation, the targeted camera is sending short clip over longer period, using any extra bandwidth available in the channel. The background upload will not affect the on-air stream. All high-quality videos should reach the studio, mixed and sent on-air as a single sequence.

FIG. 6 schematically illustrates a method 60 according to the present disclosure. The method 60 provides video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera.

The method 60 comprises the steps of selecting 61, by a stream controller, one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera. In a further step of receiving 62, the stream controller receives an instruction to provide stored HQ video content from one of said replay cameras.

In a step of instructing 63, the stream controller instructs the one of said replay cameras to provide said stored HQ video content, such that video content provided to said production studio is said stored HQ video content from said replay camera

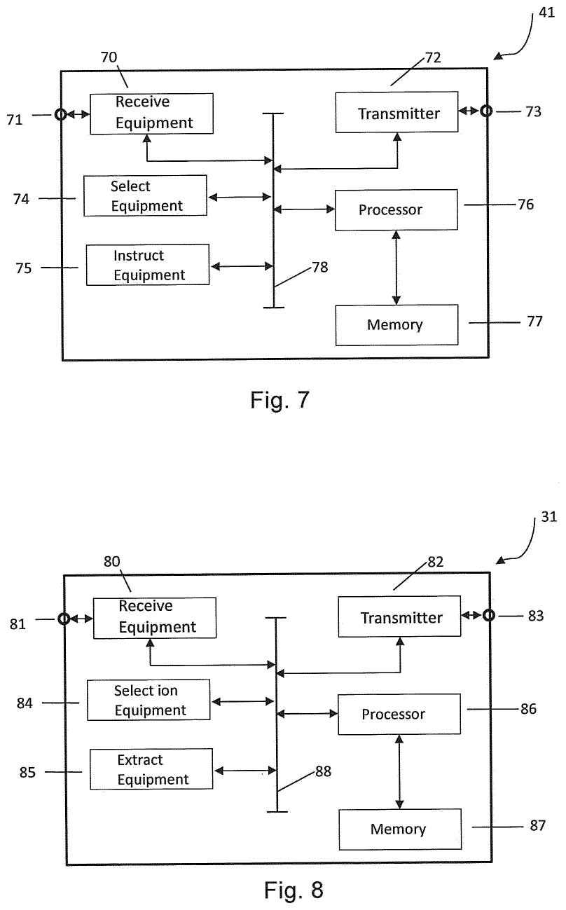

FIG. 7 schematically illustrates a stream controller 41 according to the present disclosure. The stream controller 41 is arranged to provide video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera.

The stream controller 41 comprises select equipment 74 arranged for selecting one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera.

The stream controller 41 also comprises receive equipment 70, 71 arranged for receiving an instruction to provide stored HQ video content from one of said replay cameras, and instruct equipment 75 arranged for instructing said one of said replay cameras to provide said stored HQ video content, such that video content provided to said production studio is said stored HQ video content from said replay camera.

Furthermore, the stream controller 41 may comprise of transmitter 72, 73 arranged to communicate with other entities in the system such as cameras and the live mixer etc. The memory 77 is arranged to store computer readable instructions which when executed by the processor 76 cause the stream controller to perform a method according to the present disclosure. All the internal components of the stream controller communicate with one another over an internal bus 78.

FIG. 8 schematically illustrates a video camera 31 according to the present disclosure. Although FIG. 8 and the following description only illustrates one camera 31, it may be understood that all other cameras in the system are similar. The wireless camera 31 arranged to provide video content to a production studio, wherein said wireless camera is arranged to provide said video content in at least a High Quality, HQ, format and Low Quality, LQ, format.

The wireless camera 31 comprises receive equipment 80, 81, arranged to receive a selection message from a stream controller, selection equipment 84, arranged to select either said HQ format or said LQ format for transmission to said stream controller based on said received selection message, memory 87 arranged for temporarily storing video generated by said wireless camera, and extract equipment 85, arranged for extracting video content from said stored video based on a replay instruction received from said stream controller.

The skilled person understands, that the wireless camera may comprise other components, the most obvious being video capture equipment. This is neither illustrated nor further described as it is considered to be well known. The camera 31 comprises a transmitter 82, 83 arranged for transmitting wirelessly the captured video towards the stream controller. The memory 87 is arranged to store computer readable instructions which when executed by the processor 86 cause the camera 31 to help perform a method according to the present disclosure. All the internal components of the camera 31 communicate with one another over an internal bus 88.

Other variations to the disclosed examples can be understood and effected by those skilled in the art in practicing the claimed disclosures, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid state medium supplied together with or as part of other hardware, but may also be distributed in other forms, such as via the internet or wired or wireless telecommunication systems. Any reference signs in the claims should not be construed as limiting the scope thereof.

The present disclosure is not limited to the examples as disclosed above, and can be modified and enhanced by those skilled in the art beyond the scope of the present disclosure as disclosed in the appended claims without having to apply inventive skills.

1-12. (canceled)

13. A method of providing video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera, said method comprising the steps of:
selecting, by a stream controller, one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera;
receiving, by said stream controller, an instruction to provide stored HQ video content from one of said replay cameras; and
instructing, by said stream controller, said one of said replay cameras to provide said stored HQ video content, such that video content provided to said production studio is said stored HQ video content from said replay camera.

14. The method according to claim 13, wherein said step of instructing further comprises the step of:
instructing, by said stream controller, said live camera to provide LQ live video content to said stream controller.

15. The method according to claim 13, wherein said replay cameras store said HQ video content for at least 10 minutes.

16. The method according to claim 13, wherein said stream controller stores video streams from all of said plurality of cameras to a central storage device.

17. The method according to claim 13, wherein said stream controller reassigns one of said plurality of replay cameras as a live camera and said live camera as a replay camera.

18. A stream controller arranged to provide video content to a production studio by selecting an input video stream from a plurality of wireless video cameras, wherein each of said wireless video cameras are arranged for providing at least a High Quality, HQ, and a Low Quality, LQ, video output, said wireless video cameras further comprising an internal storage arranged to locally store a video output from said wireless camera, said stream controller comprising:
select equipment arranged for selecting one among said plurality of cameras as a live camera thereby instructing said selected live camera to provide HQ video output and selecting the remaining cameras as replay cameras thereby instructing said selected replay cameras to provide LQ video output and internally store, at said replay cameras, HQ video, such that video content provided to said production studio is said HQ video output from said live camera;
receive equipment arranged for receiving an instruction to provide stored HQ video content from one of said replay cameras, and
instruct equipment arranged for instructing said one of said replay cameras to provide said stored HQ video content, such that video content provided to said production studio is said stored HQ video content from said replay camera.

19. The stream controller according to claim 18, wherein said instruct equipment is further arranged for instructing said live camera to provide LQ live video content to said stream controller.

20. The stream controller according to claim 18, wherein said stream controller stores video streams from all of said plurality of cameras to a central storage device.

21. The stream controller according to claim 18, wherein said stream controller reassigns one of said plurality of replay cameras as a live camera and said live camera as a replay camera.

22. A system for providing video content by selecting a video stream from a plurality of video streams, said system comprising:
a plurality of wireless cameras, wherein each of said wireless video cameras are arranged for providing at least a High Quality, HQ, and a Low Quality, LQ, video output, said wireless video cameras further comprising an internal storage arranged to locally store a video output from said wireless camera;
a stream controller arranged for selecting one of said plurality of cameras as a live camera and remainder of said plurality of cameras as replay cameras, said stream controller further arranged to perform a method according to claim 13, and
a production studio arranged to receive video content from said live camera selected by said stream controller.

23. A computer-readable storage medium comprising a computer program, which computer program comprises instructions which, when executed on at least one processor, cause the at least one processor to carry out a method in accordance with claim 13.
